(19) United States
(12) Patent Application Publication
(10) Pub. No.: US 2015/0041414 A1
(43) Pub. Date: Feb. 12, 2015

(54) HYDRAULIC FLUID COOLER AND FILTER

(71) Applicant: Ledwell & Son Enterprises, Inc., Texarkana, TX (US)

(72) Inventor: Andrew Squillante, Texarkana, TX (US)

(73) Assignee: Ledwell & Son Enterprises, Inc., Texarkana, TX (US)

(21) Appl. No.: 13/963,233

(22) Filed: Aug. 9, 2013

(51) Int. Cl. B01D 35/18

(52) U.S. Cl. CPC B01D 35/18
USPC 210/774; 210/184; 210/130

(57) ABSTRACT

One aspect of the invention features a hydraulic fluid cooling and filtering assembly including an inlet tank with an assembly inlet, an outlet with an assembly outlet, and a heat exchanger with multiple fluid channels where channel outlets are spaced apart along a length of the outlet tank over a flow outlet span and cross-flow air channels are formed between the fluid channels. A filter element disposed within the outlet tank includes an internal cavity in communication with the assembly outlet and porous filtering material separating the internal cavity from the heat exchanger channel outlets. The filter element is elongated and has an outer filtering surface extending along at least most of the flow outlet span of the heat exchanger; such that straight lines are defined by the respective inlets and outlets of each fluid channel that intersect the outer filtering surface which is exposed to the fluid channel outlets.

### BACKGROUND

This invention relates to a hydraulic fluid cooling and filtering assembly and a method of cooling and filtering fluid in a hydraulic system.

Hydraulic systems are used in many different applications including in vehicles such as trucks and trailers. In order to maintain a hydraulic system operating efficiently the hydraulic fluid must be maintained cool and free of particulates. There is a continual need for improved systems and methods of conditioning hydraulic fluid in hydraulic circuits.

### SUMMARY

One aspect of the invention features a hydraulic fluid cooling and filtering assembly. The assembly includes an inlet tank in hydraulic communication with an assembly inlet, an outlet tank in hydraulic communication with an assembly outlet, and a heat exchanger. The heat exchanger includes multiple fluid channels forming separate flow paths between respective fluid channel inlets at the inlet tank and respective fluid channel outlets at the outlet tank where the fluid channel outlets are spaced apart along a length of the outlet tank over a flow outlet span and cross-flow air channels are formed between the fluid channels. A filter element is disposed within the outlet tank. The filter element includes an internal cavity in hydraulic communication with the assembly outlet and porous filtering material separating the internal cavity from the heat exchanger fluid channel outlets. The filter element is elongated and has an outer filtering surface extending along at least most of the flow outlet span of the heat exchanger, and the outer filtering surface is directly exposed to the fluid channel outlets such that straight lines are defined by the respective inlets and outlets of each fluid channel of the heat exchanger that intersect the outer filtering surface, the lines passing only through fluid within the outlet tank.

In some cases, the outlet tank includes one or more ports configured to receive a fluid monitoring device. In some cases, the inlet tank includes one or more ports configured to receive a fluid monitoring device. In some examples, the heat exchanger is constructed of brazed aluminum bar-plate. In some cases, the filtering element is a self-supporting filtering element.

In some implementations the assembly is connected in a hydraulic circuit that includes a pump to motivate fluid from the assembly inlet of the inlet tank to the assembly outlet of the outlet tank through fluid flow from the assembly inlet of the inlet tank, into the inlet tank, through the multiple fluid channels, out of the heat exchanger fluid channel outlets, through the porous filtering material of the filter element, and into the internal cavity defined by the filtering element and in hydraulic communication with the assembly outlet.

In some implementations the assembly includes a bypass path in hydraulic communication with the inlet tank and with the assembly outlet and a bypass valve disposed within the bypass path to allow fluid flow from the inlet tank, through the bypass path, around the heat exchanger and the filter, and out of the assembly outlet when the bypass valve is in an open position. In some implementations the bypass valve is an electrically operated valve set to open at a threshold fluid pressure between the inlet tank and the assembly outlet.

In some implementations, the assembly includes a cover removably coupled to the outlet tank and a filter bypass valve in hydraulic communication with the outlet tank and the internal cavity defined by the filter element where the bypass valve is coupled to the cover such that removing the cover from the outlet tank removes the bypass valve. The filter bypass valve permits fluid to flow from the heat exchanger fluid channel outlets, around the porous filtering material of the filter element, and into the internal cavity defined by the filter element when the bypass valve is in an open position.

Another aspect of the invention features a hydraulic fluid cooling and filtering assembly including an inlet tank in hydraulic communication with an assembly inlet, an outlet tank in hydraulic communication with an assembly outlet, a cover removably coupled to the outlet tank, a heat exchanger, a filter element disposed within the outlet tank, and a filter bypass valve. The heat exchanger includes multiple fluid channels forming separate flow paths between respective fluid channel inlets at the inlet tank and respective fluid channel outlets at the outlet tank where the fluid channel outlets are spaced apart along a length of the outlet tank over a flow outlet span and cross-flow air channels are formed between the fluid channels. The filter element includes an internal cavity in hydraulic communication with the assembly outlet and porous filtering material separating the internal cavity from the heat exchanger fluid channel outlets. The filter bypass valve is in hydraulic communication with the outlet tank and the internal cavity defined by the filter element and the bypass valve is coupled to the cover such that removing the cover from the outlet tank removes the bypass valve. The filter bypass valve permits fluid to flow from the heat exchanger fluid channel outlets, around the porous filtering material of the filter element, and into the internal cavity defined by the filter element when the bypass valve is in an open position.

Yet another aspect of the invention features a method of cooling and filtering fluid in a hydraulic circuit including: providing a circuit having a pump and a hydraulic fluid cooling and filtering assembly with an inlet tank in hydraulic communication with an assembly inlet, an outlet tank in hydraulic communication with an assembly outlet a heat exchanger, and a filter element disposed within the outlet tank; operating the pump to move a fluid within the circuit; cooling the fluid through the heat exchanger; and filtering the cooled fluid through the filter element. The heat exchanger includes multiple fluid channels forming separate flow paths between respective fluid channel inlets at the inlet tank and respective fluid channel outlets at the outlet tank where the fluid channel outlets are spaced apart along a length of the outlet tank over a flow outlet span and cross-flow air channels are formed between the fluid channels. The filter element includes an internal cavity in hydraulic communication with the assembly outlet and porous filtering material separating the internal cavity from the heat exchanger fluid channel outlets. The filter element is elongated and has an outer filtering surface extending along at least most of the flow outlet span of the heat exchanger, such that straight lines are defined by the respective inlets and outlets of each fluid channel of the heat exchanger that intersect the outer filtering surface where the outer filtering surface is exposed to the fluid channel outlets.

In some cases the circuit also includes a hydraulic fluid reservoir and the hydraulic fluid cooling and filtering assembly is located remote from the hydraulic fluid reservoir in the circuit.

The concepts described herein may provide several advantages over cooling and filtering systems. For example, implementations of the invention may reduce the number of individual components required in hydraulic systems, enable more space-efficient hydraulic system designs, simplify hydraulic system maintenance, reduce wear and/or increase the lifespan of hydraulic system components, in certain circumstances. Implementations of the invention may be of a compact design allowing for more convenient placement of the invention in space restricted environments.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 illustrates an exemplary system incorporating an integrated hydraulic cooling and filtering assembly.

FIGS. 2A and 2B are perspective views of an exemplary integrated hydraulic cooling and filtering assembly.

FIG. 3 is a sectional view of an exemplary integrated hydraulic cooling and filtering assembly.

FIG. 4 shows an exploded view of the example outlet tank and filter bypass valve.

Like reference symbols in the various drawings indicate like elements

### DETAILED DESCRIPTION

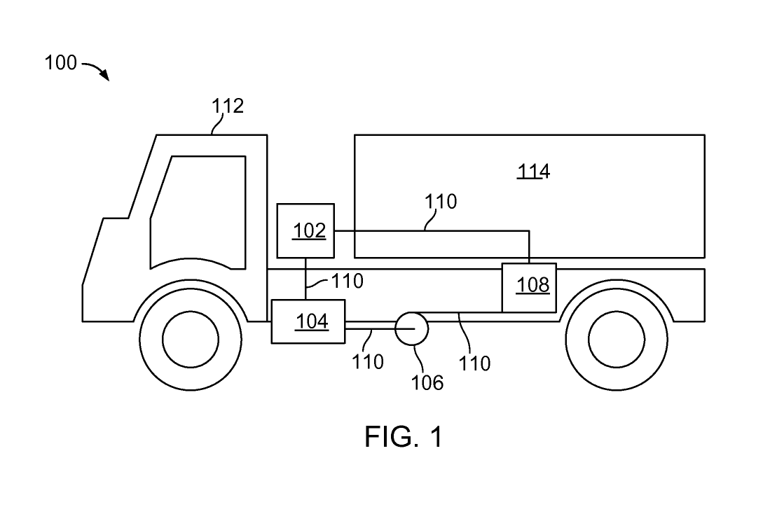

FIG. 1 illustrates an exemplary system 100 incorporating an integrated hydraulic cooling and filtering assembly 102. The system 100 is mounted on a work truck 112 and includes the integrated hydraulic cooling and filtering assembly 102, a reservoir 104, a pump 106, a hydraulic load 108, and hydraulic lines 110. The integrated hydraulic cooling and filtering assembly 102 is a pressurized assembly including both a heat exchanger for cooling the hydraulic fluid and a filter for removing particulates from the fluid. The integrated hydraulic cooling and filtering assembly 102 is described in more detail below. The reservoir 104 stores hydraulic fluid for the system 100 and supplies the hydraulic fluid to the pump 104. The reservoir 104 may include a breather cap to prevent pump cavitation. The pump 106 moves hydraulic fluid through the system 100 and withstands the pressure needed to overcome the hydraulic load 108.

The system 100 operates by either supplying pressurized hydraulic fluid to the hydraulic load 108 or venting the pressurized fluid from the hydraulic load 108 to the integrated hydraulic cooling and filtering assembly 102 to operate the hydraulic load 108. For example, the hydraulic load 108 may be hydraulic motor used to run a conveyor belt on a feed body truck 112. The components in system 100 may be rearranged in any suitable configuration and other components not illustrated may be included. For example, additional components may include hydraulic motors, hydraulic cylinders, control valves, actuators, or accumulators.

Although a work truck is illustrated in system 100 the hydraulic system and integrated hydraulic cooling and filtering assembly 102 may be used in various other suitable applications related to vehicles, heavy equipment, vessels (i.e., ships and boats), and other suitable hydraulic systems.

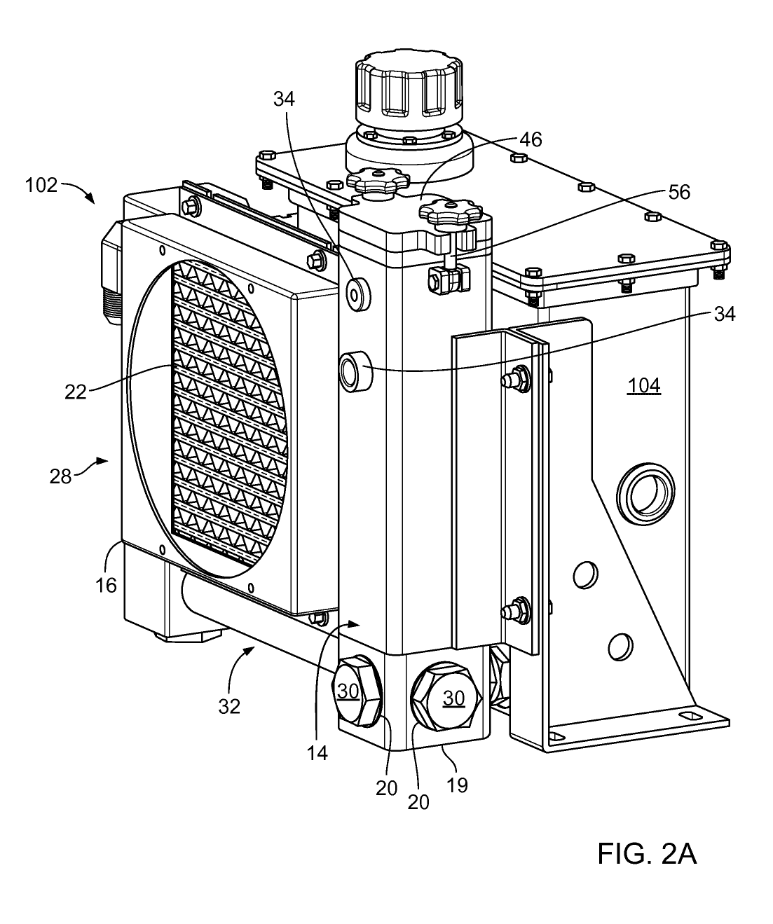

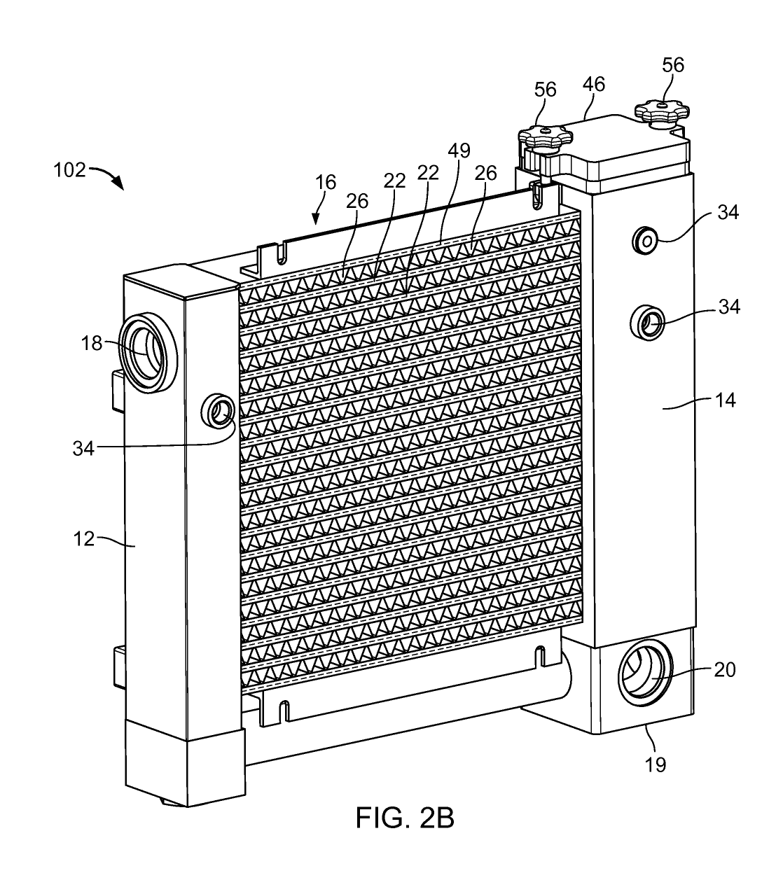

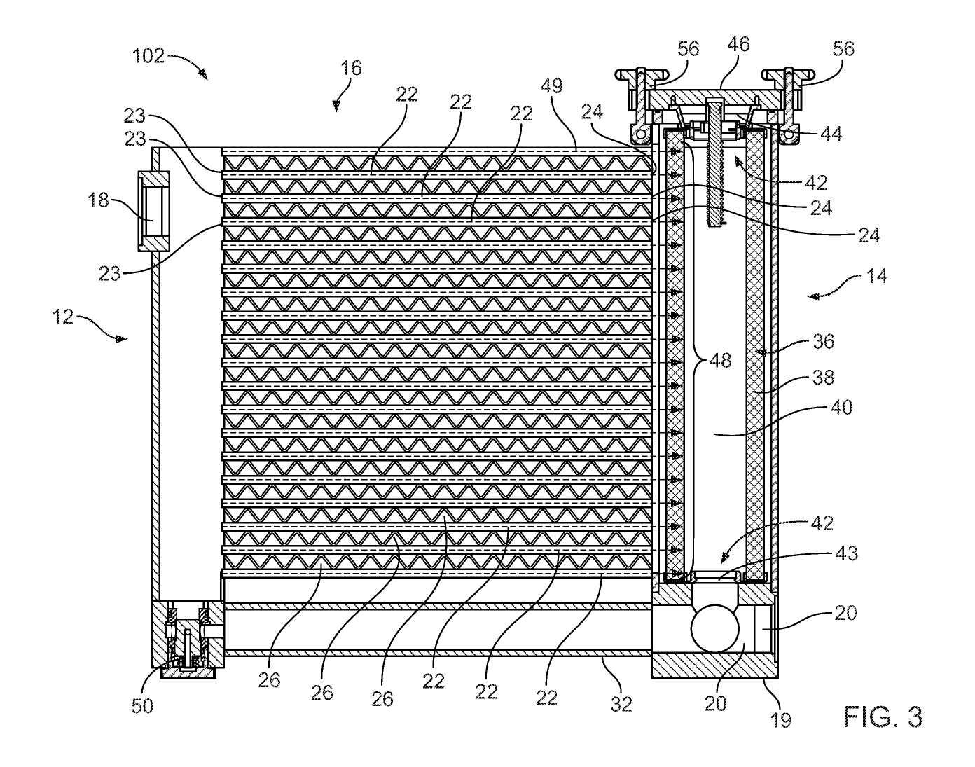

FIGS. 2A and 2B are perspective views of an exemplary integrated hydraulic cooling and filtering assembly 102 and FIG. 3 is a sectional view of an exemplary integrated hydraulic cooling and filtering assembly 102. Referring to FIGS. 2A and 2B, the integrated hydraulic cooling and filtering assembly 102 includes an inlet tank 12, an outlet tank 14, and a heat exchanger 16. The inlet 12 and outlet 14 tanks are pressurized tanks connected (i.e., welded) at opposite ends of the heat exchanger 16. The inlet tank 12 includes an assembly inlet 18 and is in hydraulic communication with one end of the heat exchanger 16. The outlet tank 14 includes an assembly outlet manifold 19 with one or more assembly outlets 20 and is in hydraulic communication with the opposite end of the heat exchanger 16. Plugs 30 are inserted into some of the assembly outlets 20 when they are not in use. Additionally, the assembly outlets 20 can be used as alternate return ports to bypass the cooler and filter, if desired. The plugs 30 may be threaded plugs, as shown, or other suitable types. Together with the heat exchanger 16, inlet tank 12, and outlet tank 14 form a integrated pressurized assembly. The heat exchanger 16, inlet tank 12, and outlet tank 14 are constructed of aluminum, though other suitable materials may be used, for example steel or other alloys or metals.

The heat exchanger 16 is a brazed aluminum bar-plate construction including a plurality of fluid channels 22 configured to allow hydraulic fluid to flow from the inlet tank 12 through the fluid channels 22 and into the outlet tank 14. The heat exchanger 16 may be constructed of other appropriate metals or alloys, in some implementations. As shown in FIG. 3 and described in more detail below, the inlet tank 12 is connected to respective fluid channel inlets 23 and the outlet tank 14 is connected to respective fluid channel outlets 24. The fluid channel inlets 23 and outlets 24 terminate at respective openings defined within inboard walls of the inlet 12 and outlet 14 tanks. The channels 22 are composed of a thermally conductive material (e.g., aluminum) such that hydraulic fluid is cooled as it passes through the channels 22. The spacing between the fluid channels 22 define cross-flow air channels 26 to conduct heat away from the hydraulic fluid within the channels 22 to air in the cross-flow air channels 26. In some implementations, the heat exchanger 16 may include a fan to force air through the cross-flow air channels 26 and improve the cooling efficiency of the heat exchanger 16. In addition, the heat exchanger 16 may include a fan shroud 28 for attaching the fan to the heat exchanger 16 to increase thermal transfer efficiency.

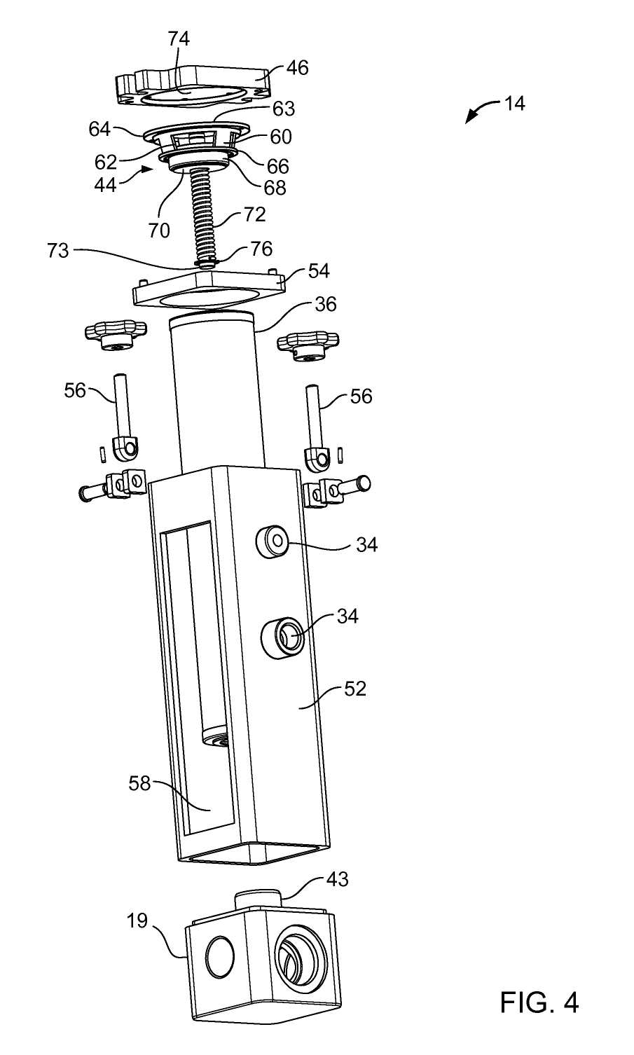

In addition, the outlet tank includes a removable tank cover 46 to access a filter element (element 36 of FIGS. 3 and 4) disposed within the outlet tank 14. Two or more swing bolts 56 attached to the outlet tank 14 retain the tank cover 46 in place, although other appropriate fasteners may be used, for example a threaded tank cap.

In some implementations, the heat exchanger 16 may be constructed as a tube and fin heat exchanger. In such an implementation, a plurality of fluid tubes may define the fluid channels 22 with a plurality of metal fins interspersed between the tubes within the cross-flow air channels 26 and in thermal contact and mechanical contact with the tubes.

The heat exchanger 16 may be air cooled, as shown, or in some implementations, may be liquid cooled, for example, using water, a liquid refrigerant, or other appropriate coolant. In such an implementation the cross-flow air channels 26 may be replaced with coolant channels in thermal contact with the fluid channels 22.

In addition, the inlet 12 and outlet 14 tanks include at least one port 34 configured to receive a fluid monitoring device such as a pressure gauge, transducer, or a thermocouple. The fluid monitoring device may be used to control a fan, provide indication of the condition of a filter element 36, or control one or more valves, for example. In some implementations, as shown in FIG. 2A, the integrated hydraulic cooling and filtering assembly 102 may be directly mounted to a reservoir 104 to which one of the assembly outlets 20 is connected.

Referring to FIG. 3, the outlet tank 14 houses a filter element 36. The filter element 36 includes a cylinder of porous, generally pleated, filtering material 38 defining an internal cavity 40 and openings 42 at either end. The filter is placed in the outlet tank 14 with a nipple 43 on the assembly outlet manifold 19 at the bottom of the outlet tank 14 fits into an opening 42 at the lower end of the filter element 36 forming a seal between the bottom of the outlet tank 14 and the filter element 36. In addition, the nipple 43 provides a flow path to the assembly outlet manifold 19 and the assembly outlets 20 aids in properly positioning the filter element 36 within the outlet tank 14. The upper end of the filter element 36 forms a seal against a lower flange (element 66 in FIG. 4) of the filter bypass valve 44 (described in more detail below with reference to FIG. 4) which is attached to the tank cover 46. The seals created between the filter element 36 and the bottom of the outlet tank 14 and the bypass valve 44 prevent fluid flow around the filtering material 38 and into the internal cavity 40 of the filter element 36. Thus, the filtering material 38 forms a fluid separation between the internal cavity 40 and the fluid channel outlets 24. A tube sheet formed by the fluid channel outlets 24 defines a flow outlet span 48 from which all of the fluid exiting the heat exchanger 16 fluid channels 22 enters the outlet tank 14 and is distributed across an outer surface of the filter element 36 defined by the filtering material 38. The filter element 36 is disposed within the outlet tank 14 such that the filtering material 38 extends along the flow outlet span 48 of the heat exchanger 16 as defined by the fluid channel outlets 24. The respective inlets 23 and outlets 24 of each fluid channel 22 define straight lines 49 that intersect the outer filtering surface of the filter element 36. Positioning the filter element 36 within the outlet tank 14 as described reduces the average distance that incoming fluid must flow through the outlet tank before passing through the filter element, which may help to equalize flow distribution through the filter material, thereby prolonging filter life by distributing filtered sediment. This arrangement may also help to prevent accumulation of sediment falling out of suspension due to flow direction changes between the outlets and the filter surface.

Although it is not required that the outer surface of the filtering material 38 extend along the entire heat exchanger 16 flow outlet span 48, the filtering material 38 should extend along a substantial portion of the flow outlet span 48. Likewise, it is not necessary that the flow outlet span 48 extend along the entire length or diameter of the filtering element 36 (i.e., either vertically or horizontally). For example, the flow outlet span 48 may encompass an area either larger or smaller than that defined by the filter element 36. Although the filter element 36 is preferably aligned with the channel outlets 24 and the outlet span 48, the filter element 36 may be offset vertically or horizontally from the flow outlet span 48. Thus disposed within the outlet tank 14, the filtering material 38 forms a fluid separation between the internal cavity 40 and the fluid channel outlets 24.

Furthermore, the filter element 36 is disposed directly within the outlet tank 14 without the additional support of a separate filter chamber or filter screen. Such a design improves the flow capacity through the filter element 36 and the outlet tank 14 by exposing the outer filtering surface of the filter element 36 directly to the fluid channel outlets 24 and thus avoiding any restrictions or impediments to the oil flow caused by either a separate filter chamber or screen itself or by build-up of foreign material in openings of such a separate filter chamber or screen. For example, the filter element 36 of the described design may be considered to be a self-supporting filter in that the filter element 36 does not require additional structural support or an additional pre-filtering/screening element. In addition, the described design reduces the maintenance required to maintain a hydraulic system by eliminating the need to clean or flush openings of such separate filter chambers or screens and by making the filter element 36 easily accessible and replaceable.

In addition, the inlet 12 and outlet 14 tanks are hydraulically connected to each other via a heat exchanger bypass path 32 (e.g., bypass pipe). One end of the bypass path connects to a bottom portion of the inlet tank 12 while the other end connects to the assembly outlet manifold 19 of the outlet tank 14. The bypass path 32 provides an alternate flow path around both the heat exchanger 16 and the outlet tank 14. A bypass valve 50 is disposed between the inlet tank 12 and the bypass path 32 to prevent fluid flow through the bypass path 32 during normal operation of the integrated hydraulic cooling and filtering assembly 102. The bypass valve 50 may be a manual bypass valve, a mechanically pressure operated valve, an electrically operated cartridge valve, or a hybrid mechanical/electrical valve. For example, a pressure operated valve may be used to protect both the heat exchanger 16 and the filter element 36 from high differential pressure caused by buildup in the fluid channels 22 or pressure surges within a hydraulic system. An electrically operated bypass valve may configure to open and shut based on either temperature or pressure. For example, an electrically operated valve may be connected to temperature sensors in ports 34 in the inlet and/or outlet tanks 12, 14 and configured throttle flow through the bypass path 32 to maintain system temperature within a specified range. Whereas, a hybrid valve may be an electrically operated valve that also includes a means for opening mechanically, either manually or based on differential pressure.

FIG. 4 shows an exploded view of the example outlet tank 14 and filter bypass valve 44. In more detail, the outlet tank 14 includes an assembly outlet manifold 19, welded to a bottom portion of an outlet tank body 52, a cover alignment element 54 welded, or otherwise coupled, to a top portion of the outlet tank body 52, the filter bypass valve 44, the tank cover 46, and swing bolts 56 to fasten the tank cover 46 to the cover alignment element 54. The outlet tank body 52 includes an opening 58 for receiving a tube sheet that defines the heat exchanger 16 fluid channel outlets 24 which is welded, or otherwise coupled, in connection with the body 52. Internal corners within the outlet tank body 52 may be rounded to promote efficient fluid flow within the outlet tank 14. In addition, a seal (e.g., an gasket or O-ring) may be positioned between the tank cover 46 and the cover alignment element 54.

The tank cover 46 is removable to allow easy access to the filter element 36 and the filter bypass valve 44. The cover alignment element 54 have small protrusions which align with corresponding pockets on the inside surface of the tank cover 46 ensure proper alignment of the cover 46. The tank cover 46 is then retained in place by the swing bolts 56. In addition, the filter bypass valve 44 is coupled to the inside surface of the tank cover 46 such that when the tank cover 46 is removed the filter bypass valve 44 will be withdrawn from the filter element 36 and removed from the outlet tank 14 as well. Thus configured, the bypass valve 44 is easily removable for service or replacement without requiring disassembly of either the outlet tank 14 or the integrated hydraulic cooling and filtering assembly 102.

The filter bypass valve 44 includes a body 60 defining at least one cross-flow port 62 and including a upper portion 63 with an upper flange 64, a lower flange 66, a nipple portion 68, a bypass disc 70, and a captured spring 72. The upper flange 64 of the filter bypass valve 44 rests in a recess 74 of the tank cover 46 and is retained by fasteners (e.g., screws). When the tank cover 46 is in place on the outlet tank 14, the lower flange 66 and nipple portion 68 of the filter bypass valve 44 form a seal with one of the openings 42 of the filter element 36; the nipple portion 68 extending slightly into the filter element's 36 internal cavity 40. The captured spring 72 extends along a guide rod 73 and is retained at one end by a fastener 76 (e.g., a nut or a snap ring) and applies pressure to a bottom surface of the bypass disc 70 at the other end. The guide rod 73 extends through the filter bypass valve body 60 and attaches to the upper portion 63 of the filter bypass valve body 60. When positioned within the outlet tank 14, the guide rod 73 and captured spring 72 assembly extends into the internal cavity 40 of the filter element 36 as shown in FIG. 3.

In operation, fluid flows through the filter bypass valve body 60 via the cross-flow ports 62. The bypass disc 70 is forced against the nipple portion 68 by the captured spring 72 forming a seal and preventing the fluid from entering the filter element's 36 internal cavity 40 via the filter bypass valve 44. The captured spring 72 maintains the filter bypass valve 44 in a closed position until the differential pressure across the filtering material 38 becomes sufficient to force the bypass disc 70 away from the filter bypass valve body 60 against spring pressure (e.g., 25 psid). The nipple portion 68 defines an opening in the filter bypass valve body 60 that permits fluid flow around the filtering material 38 and into the filter element's 36 internal cavity 40 when the valve is in an open position.

Referring again to FIG. 3, during normal operation of the integrated hydraulic cooling and filtering assembly 102, hydraulic fluid flows from the hydraulic system into the inlet tank 12 through the assembly inlet 18. The fluid fills the inlet tank 12 and flows into the heat exchanger 16 fluid channels 22 through fluid channel inlets 23. Heat is removed from the fluid as the fluid passes through the fluid channels 22 and transferred through the fluid channel 22 walls to air that is passed through the cross-flow air channels 26. The fluid then exits the fluid channels 22 through fluid channel outlets 24 entering the outlet tank 14 in an even distribution across the filter element 36. The fluid then flows through the porous filtering material 38 and into the filter element's 36 internal cavity 40. The fluid flows axially inside the internal cavity 40 and exits the internal cavity 40 through the nipple 43 on the assembly outlet manifold 19. Finally, the fluid exits the integrated hydraulic cooling and filtering assembly through one or more of the assembly outlets 20.

Hydraulic fluid can be cooled and filtered by a method including providing a hydraulic circuit with an integrated hydraulic cooling and filtering assembly and a hydraulic pump; and operating the pump to move a fluid within the circuit such that the fluid is cooled through the heat exchanger 16 and the cooled fluid filtered through the filter element 36. The hydraulic circuit includes an integrated hydraulic cooling and filtering assembly 102 (as described above) with an inlet tank 12, a heat exchanger 16, and an outlet tank and a hydraulic pump. A suction end of the hydraulic pump is connected in hydraulic communication with an assembly outlet 20 of the integrated hydraulic cooling and filtering assembly 102 and a discharge of the hydraulic pump connected in hydraulic communication with an assembly inlet 18 of the integrated hydraulic cooling and filtering assembly 102. Additional hydraulic system components (e.g., a reservoir, valves, hydraulic loads, etc.) may be connected between either the assembly outlet 20 and the pump suction or between the pump discharge and the assembly inlet. The outlet tank 14 includes a filter element 36 as described above. The circuit also may include additional components connected in hydraulic communication between the pump discharge and the integrated hydraulic cooling and filtering assembly inlet 18 or between the integrated hydraulic cooling and filtering assembly outlet 20 and the pump suction or between both locations. For example, such additional components may include reservoirs, hydraulic motors, hydraulic cylinders, control valves, actuators, accumulators, or additional pumps or integrated hydraulic cooling and filtering assemblies 102. They integrated hydraulic cooling and filtering assembly 102 is of a compact design and therefore may be located remote from other hydraulic system components, such as a hydraulic fluid reservoir. For example, in a space restricted environment, such as work trucks, the integrated hydraulic cooling and filtering assembly may be installed remote from a larger hydraulic reservoir, thereby allowing for more efficient use of space in the truck design.

While a number of examples have been described for illustration purposes, the foregoing description is not intended to limit the scope of the invention, which is defined by the scope of the appended claims. There are and will be other examples and modifications within the scope of the following claims.

1. A hydraulic fluid cooling and filtering assembly (102) comprising:
an inlet tank (12) in hydraulic communication with an assembly inlet (18);
an outlet tank (14) in hydraulic communication with an assembly outlet (20);
a heat exchanger (16) defining:
multiple fluid channels (22) forming separate flow paths between respective fluid channel inlets (23) at the inlet tank and respective fluid channel outlets (24) at the outlet tank, the fluid channel outlets spaced apart along a length of the outlet tank over a flow outlet span (48), and
cross-flow air channels (26) between the fluid channels; and
a filter element (36) disposed within the outlet tank (14), the filter element defining an internal cavity (40) in hydraulic communication with the assembly outlet (20) and comprising porous filtering material (38) separating the internal cavity from the heat exchanger fluid channel outlets,
wherein the filter element (36) is elongated and has an outer filtering surface extending along at least most of the flow outlet span (48) of the heat exchanger (16), and
wherein the outer filtering surface is directly exposed to the fluid channel outlets (24) such that straight lines (49) defined by the respective inlets (23) and outlets (24) of fluid channels (22) of the heat exchanger (16) intersect the outer filtering surface, passing only through fluid within the outlet tank.

2. The hydraulic fluid cooling and filtering assembly of claim 1, connected in a hydraulic circuit and further comprising:
a pump that motivates fluid from the assembly inlet of the inlet tank to the assembly outlet of the outlet tank through fluid flow from the assembly inlet of the inlet tank, into the inlet tank, through the multiple fluid channels, out of the heat exchanger fluid channel outlets, through the porous filtering material of the filter element, and into the internal cavity defined by the filtering element and in hydraulic communication with the assembly outlet.

3. The hydraulic fluid cooling and filtering assembly of claim 1, further comprising:
a bypass path in hydraulic communication with the inlet tank and with the assembly outlet
a bypass valve disposed within the bypass path to allow fluid flow from the inlet tank, through the bypass path, around the heat exchanger and the filter, and out of the assembly outlet when the bypass valve is in an open position,
wherein the bypass valve is an electrically operated valve set to open at a threshold fluid pressure between the inlet tank and the assembly outlet.

4. The hydraulic fluid cooling and filtering assembly of claim 1, wherein the filtering element is a self-supported filtering element.

5. The hydraulic fluid cooling and filtering assembly of claim 1, further comprising:
a cover removably coupled to the outlet tank; and
a filter bypass valve in hydraulic communication with the outlet tank and the internal cavity defined by the filter element, the bypass valve coupled to the cover such that removing the cover from the outlet tank removes the bypass valve,
wherein the filter bypass valve permits fluid to flow from the heat exchanger fluid channel outlets, around the porous filtering material of the filter element, and into the internal cavity defined by the filter element when the bypass valve is in an open position.

6. The hydraulic fluid cooling and filtering assembly of claim 1, wherein the outlet tank includes one or more ports configured to receive a fluid monitoring device.

7. The hydraulic fluid cooling and filtering assembly of claim 1, wherein the inlet tank includes one or more ports configured to receive a fluid monitoring device.

8. The hydraulic fluid cooling and filtering assembly of claim 1, wherein the heat exchanger is constructed of brazed aluminum bar-plate.

9. A hydraulic fluid cooling and filtering assembly comprising:
an inlet tank (12) in hydraulic communication with an assembly inlet (18);
an outlet tank (14) in hydraulic communication with an assembly outlet (20);
a cover (46) removably coupled to the outlet tank;
a heat exchanger (16) defining:
multiple fluid channels (22) forming separate flow paths between respective fluid channel inlets (23) at the inlet tank and respective fluid channel outlets (24) at the outlet tank, the fluid channel outlets spaced apart along a length of the outlet tank over a flow outlet span (48), and
cross-flow air channels (26) between the fluid channels;
a filter element (36) disposed within the outlet tank (14), the filter element defining an internal cavity (40) in hydraulic communication with the assembly outlet (20) and comprising porous filtering material (38) separating the internal cavity from the heat exchanger fluid channel outlets; and
a filter bypass valve (44) in hydraulic communication with the outlet tank and the internal cavity defined by the filter element, the bypass valve coupled to the cover (46) such that removing the cover from the outlet tank removes the bypass valve (44),
wherein the filter bypass valve (44) permits fluid to flow from the heat exchanger fluid channel outlets (24), around the porous filtering material (38) of the filter element (36), and into the internal cavity (40) defined by the filter element (36) when the bypass valve (44) is in an open position.

10. The hydraulic fluid cooling and filtering assembly of claim 9, connected in a hydraulic circuit and further comprising:
a pump that motivates fluid from the assembly inlet of the inlet tank to the assembly outlet of the outlet tank through fluid flow from the assembly inlet of the inlet tank, into the inlet tank, through the multiple fluid channels, out of the heat exchanger fluid channel outlets, through the porous filtering material of the filter element, and into the internal cavity defined by the filtering element and in hydraulic communication with the assembly outlet.

11. The hydraulic fluid cooling and filtering assembly of claim 9, further comprising:
a bypass path in hydraulic communication with the inlet tank and with the assembly outlet
a bypass valve disposed within the bypass path to allow fluid flow from the inlet tank, through the bypass path, around the heat exchanger and the filter, and out of the assembly outlet when the bypass valve is in an open position,
wherein the bypass valve is an electrically operated valve set to open at a threshold fluid pressure between the inlet tank and the assembly outlet.

12. The hydraulic fluid cooling and filtering assembly of claim 9, wherein the filter element is elongated and has an outer filtering surface extending along at least most of the flow outlet span 48 of the heat exchanger, and
wherein the outer filtering surface is directly exposed to the fluid channel outlets, such that straight lines defined by the respective inlets and outlets of fluid channels of the heat exchanger intersect the outer filtering surface.

13. The hydraulic fluid cooling and filtering assembly of claim 9, wherein the filtering element is a self-supported filtering element.

14. The hydraulic fluid cooling and filtering assembly of claim 9, wherein the outlet tank includes one or more ports configured to receive a fluid monitoring device.

15. The hydraulic fluid cooling and filtering assembly of claim 9, wherein the inlet tank includes one or more ports configured to receive a fluid monitoring device.

16. The hydraulic fluid cooling and filtering assembly of claim 9, wherein the heat exchanger is constructed of brazed aluminum bar-plate.

17. A method of cooling and filtering fluid in a hydraulic circuit comprising:
providing a circuit having:
a pump, and
a hydraulic fluid cooling and filtering assembly including:
an inlet tank in hydraulic communication with an assembly inlet,
an outlet tank in hydraulic communication with an assembly outlet;
a heat exchanger defining multiple fluid channels forming separate flow paths between respective fluid channel inlets at the inlet tank and respective fluid channel outlets at the outlet tank, the fluid channel outlets spaced apart along a length of the outlet tank over a flow outlet span 48, and
a filter element disposed within the outlet tank, the filter element defining an internal cavity in hydraulic communication with the assembly outlet and comprising porous filtering material separating the internal cavity from the heat exchanger fluid channel outlets,
wherein the filter element is elongated and has an outer filtering surface extending along at least most of the flow outlet span of the heat exchanger, and
wherein the outer filtering surface is directly exposed to the fluid channel outlets, such that straight lines defined by the respective inlets and outlets of each
fluid channel of the heat exchanger intersect the outer filtering surface;
operating the pump to move a fluid within the circuit;
cooling the fluid through the heat exchanger, and
filtering the cooled fluid through the filter element.

18. The method of claim 17, wherein the circuit further includes a hydraulic fluid reservoir, and wherein the hydraulic fluid cooling and filtering assembly is located remote from the hydraulic fluid reservoir in the circuit.
